(19) United States
(12) Patent Application Publication
(10) Pub. No.: US 2004/0015970 A1
(43) Pub. Date: Jan. 22, 2004

(54) Method and system for data flow control of execution nodes of an adaptive computing engine (ACE)

(76) Inventor: W. James Scheuermann, Saratoga, CA (US)

Correspondence Address: Joseph A. Sawyer, Jr., SAWYER LAW GROUP LLP, P.O. Box 51418, Palo Alto, CA, 94303, US

(21) Appl. No.: 10/092,859

(22) Filed: Mar. 6, 2002

(51) Int. Cl. G06F 9/00

(52) U.S. Cl. 718/102

(57) ABSTRACT

Aspects for data flow control of execution nodes of an adaptive computing engine (ACE) are presented. The aspects include associating task parameters with tasks within an execution node. Readiness of task resources is identified based on a status of the task parameters. Subsequently, allocation of the tasks to the execution node occurs based on the readiness of task resources.

### FIELD OF THE INVENTION

The present invention relates to data flow control during task execution in an adaptive processing system.

### BACKGROUND OF THE INVENTION

The electronics industry has become increasingly driven to meet the demands of high-volume consumer applications, which comprise a majority of the embedded systems market. Embedded systems face challenges in producing performance with minimal delay, minimal power consumption, and at minimal cost. As the numbers and types of consumer applications where embedded systems are employed increases, these challenges become even more pressing. Examples of consumer applications where embedded systems are employed include handheld devices, such as cell phones, personal digital assistants (PDAs), global positioning system (GPS) receivers, digital cameras, etc. By their nature, these devices are required to be small, low-power, light-weight, and feature-rich.

In the challenge of providing feature-rich performance, the ability to produce efficient utilization of the hardware resources available in the devices becomes paramount. As in most every processing environment that employs multiple processing elements, whether these elements take the form of processors, memory, register files, etc., of particular concern is controlling the flow of data and task execution within and among the multiple processing elements. Accordingly, what is needed is a manner of controlling the flow of data for efficient task execution in an adaptive processing system. The present invention addresses such a need.

### SUMMARY OF THE INVENTION

Aspects for data flow control of execution nodes of an adaptive computing engine (ACE) are presented. The aspects include associating task parameters with tasks within an execution node. Readiness of task resources is identified based on a status of the task parameters. Subsequently, allocation of the tasks to the execution node occurs based on the readiness of task resources.

Through the present invention, data flow control techniques are achieved that provide for efficient and straightforward task execution pacing in execution nodes of an adaptive processing system. These and other advantages will become readily apparent from the following detailed description and accompanying drawings.

### BRIEF DESCRIPTION OF THE DRAWINGS

FIG. 1 illustrates an execution node diagram of an adaptive computing engine (ACE) in accordance with the present invention.

FIG. 2 illustrates a more detailed illustration of the execution node.

FIG. 3 illustrates a block flow diagram of data flow control for task execution within the execution node in accordance with the present invention.

FIG. 4 illustrates a block diagram of a system for data flow control in accordance with the present invention.

### DETAILED DESCRIPTION OF THE INVENTION

The present invention relates to data flow control during task execution in an adaptive processing system. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

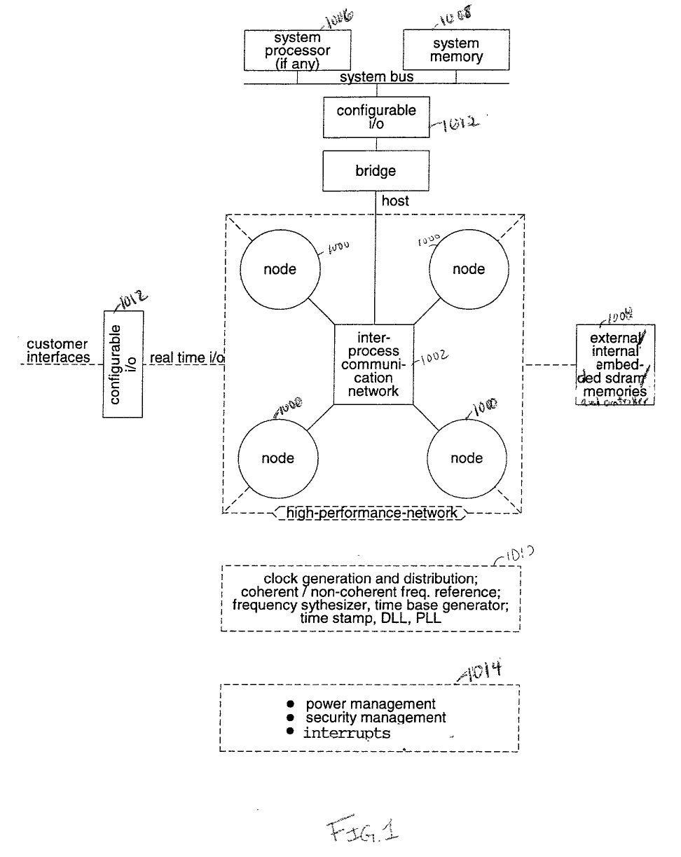

The aspects of the present invention relate to task flow control in an adaptive computing engine (ACE). In general, an ACE refers to a silicon die which integrates a number of compatible, high-performance, scalable computing elements, memories, input/output ports, and associated infrastructure to provide efficient implementations for various applications. As shown in FIG. 1, the ACE principally include heterogeneous nodes 1000, a homogeneous network 1002 with a flexible input/output subsystem and bulk memory interfaces to high performance memory controllers and associated memories 1004, a system bus interface to a system processor (if present) 1006, system memory 1008, and their associated services, and an infrastructure that includes clocking 1010, configurable I/O (input/output) 1012, and power management, security management, and interrupts 1014. The heterogeneous nodes 1000 are interconnected suitably by the homogeneous network 1002 using a by-four fractal to support scaling to any number of nodes. A more detailed discussion on the node structure and interconnection network of the ACE is presented in copending U.S. patent application Ser. No. 09/898,350, entitled “Method and System for an Interconnection Network to Support Communications Among a Plurality of Heterogeneous Processing Elements”, and filed Jul. 3, 2001, which is assigned to the assignee of the present invention and incorporated herein by reference in its entirety.

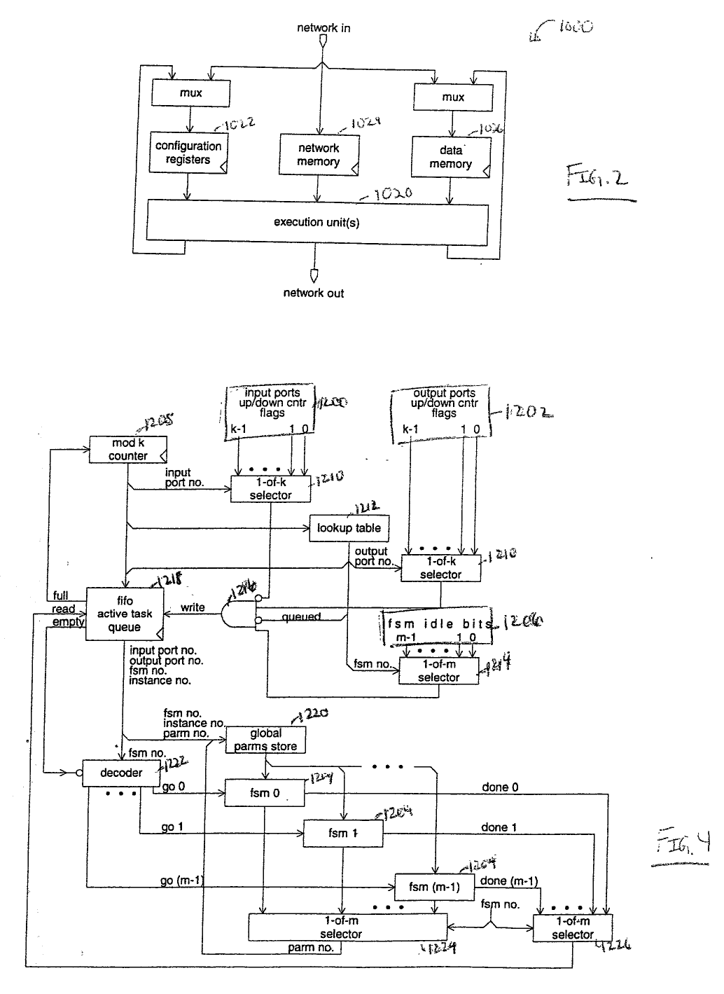

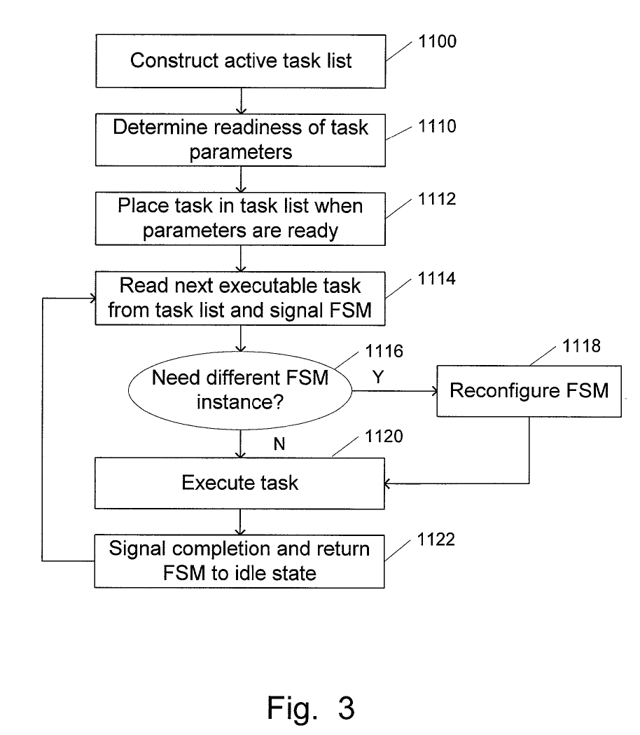

A diagram for a node shown in FIG. 2 illustrates that each node 1000 includes an execution unit 1020 coupled to memory 1006 in the form of registers 1022, network memories 1024, and data memories 1026, and network interfaces, network in/network out. Streaming the data within and among the nodes 1000 in the network 1002 for task execution is achieved through the aspects of data flow control in accordance with the present invention. The aspects are described with reference to nodes 1000 which contain one or more finite state machine-based, parameterizable, reconfigurable computational elements, i.e., a reconfigurable node (R-node), that capably performs any of a number of tasks, including, for example, signal processing, such as FIR filtering, IIR filtering, FFT, DCT, IDCT, convolution/correlation, convolutional encoding and Viterbi decoding, Huffinan encoding and decoding, encryption and decryption, and LSFR/PN sequence generation. It should be appreciated that these aspects may be applied to other types of nodes, including, for example, fully programmable nodes, and hybrid nodes, which contain both programmable and reconfigurable execution units. In accordance with the present invention, data flow techniques are used to pace the task execution by the execution unit within the nodes, as presented with reference to the block flow diagram of FIG. 3 and system diagram of FIG. 4.

In considering an R-node having number ‘k’ input ports, ‘k’ output ports, ‘m’ fsm-controlled execution units (fsm), and up to ‘i’ instances for each fsm, the data flow control techniques of the present invention begin with construction of an active task list in the form of a queue (step 1100). In order to construct the task list, the status of task parameters is determined (step 1110). These task parameters indicate whether a task is executable and ready for placement in the task list. For a given task to be executable, the necessary input buffer(s) and output buffer(s) must be available and the fsm(s) must be in an idle state. Once all the parameters have satisfied the condition requirements, the task is placed in the queue (step 1112).

The issuance of tasks from the queue proceeds based on the status of the fsms. Whenever all fsms are idle and the queue is not empty, the next executable task is read from the queue and the ‘go’ signal of the corresponding fsm is asserted (step 1114). If the current instance of the fsm is different form the previous instance, as determined via step 1116, the fsm is reconfigured (step 1118). Task execution ensues, i.e., data is read from the input port, processed, and written to the output port (step 1120). When the task completes, the ‘done’ signal is generated, and the fsm re-enters its ‘idle’ state (step 1122). The process continues by issuing a next executable task from the task queue.

Referring now to FIG. 4, in determining the status of the task parameters, up/down counter flags suitably indicate availability of each input port/buffer 1200 and each output port/buffer 1202. A status of an idle signal for each fsm 1204 is also tracked 1206. As is further shown in FIG. 4, a counter value 1208 is utilized as a signal for selectors 1210 receiving the flag status for a particular input port and output port and as a signal for a lookup table 1212 for selecting a corresponding fsm 1204 via a selector 1214. The signals from the selectors 1210 are combined logically, e.g. via an AND gate 1216, to provide a write signal to allow the task and its parameters to be added to the task list in the queue 1218. A data structure 1220 binds parameters identifying, by number, an input port, an output port, an fsm, and an instance of that fsm associated with each task, where an instance refers to a variation in performance by a particular fsm. For example, an fsm may be configured to perform Viterbi decoding with different constraint lengths. Thus, for each constraint length, a separate instance of the decoder would be utilized. Decoder 1222 and selectors 1224 and 1226 are also included as part of the flow control logic for tracking fsm status during task execution.

With the present invention, data flow control techniques are achieved that provide for efficient and straightforward task execution pacing in execution nodes of an adaptive processing system. The techniques further provide for consistency and uniformity for application across any and all node types within the system. Thus, the techniques are well-suited to accommodate expansion in the network of nodes.

From the foregoing, it will be observed that numerous variations and modifications may be effected without departing from the spirit and scope of the novel concept of the invention. Further, it is to be understood that no limitation with respect to the specific methods and apparatus illustrated herein is intended or should be inferred. It is, of course, intended to cover by the appended claims all such modifications as fall within the scope of the claims.

What is claimed is:

1. A method for data flow control of a plurality of execution nodes of an adaptive computing engine (ACE), the method comprising:
(a) associating a plurality of task parameters with a plurality of tasks within an execution node;
(b) identifying readiness of a plurality of task resources based on a status of the task parameters; and
(c) pacing allocation of the plurality of tasks to the execution node based on the readiness the plurality of task resources.

2. The method of claim 1 wherein the execution node includes a reconfigurable execution unit.

3. The method of claim 2 wherein the reconfigurable execution unit further comprises one or more finite state machines.

4. The method of claim 1 wherein the task parameters identify, by designation, an input port, an output port, a finite state machine, and a finite state machine instance.

5. The method of claim 4 wherein identifying a readiness step (b) further comprises the step of (b1) identifying a task as an executable task when the input port is available, the output port is available, and the finite state machine is idle.

6. The method of claim 1 further comprising the step of (d) aggregating executable tasks in a queue.

7. The method of claim 6 wherein allocation pacing step (c) further comprises the steps of (c1) reading a next executable task from the queue and (c2) generating a signal to start execution in the finite state machine associated with the next executable task.

8. The method of claim 7 further comprising the steps (e) of reconfiguring the finite state machine from one instance to another as necessary, reading data from the input port, (f) processing the data in the finite state machine, and (g) writing the data to the output port.

9. The method of claim 8 further comprising the steps of (h) generating a signal indicating completion of the execution in the finite state machine and (c) re-entering an idle state in the finite state machine.

10. The method of claim 4 wherein the designation comprises a number.

11. A system for flow control in processing nodes of an adaptive computing engine (ACE), the system comprising:
a reconfigurable execution unit; and
flow control logic coupled to the reconfigurable execution unit for associating tasks and task parameters, identifying readiness of task resources based on a status of the task parameters, and pacing allocation of the tasks to the reconfigurable execution unit based on the readiness of task resources.

12. The system of claim 11 wherein the reconfigurable execution unit further comprises one or more finite state machines.

13. The system of claim 11 wherein the task parameters identify, by designation, an input port, an output port, a finite state machine, and a finite state machine instance.

14. The system of claim 13 wherein the designation comprises a number.

15. The system of claim 13 wherein the flow control logic further identifies a task as an executable task when the input port is available, the output port is available, and the finite state machine is idle.

16. The system of claim 12 further comprising a queue for aggregating executable tasks.

17. The system of claim 16 wherein the flow control logic reads a next executable task from the queue and generates a signal to start execution in the finite state machine associated with the next executable task.

18. The system of claim 13 wherein the finite state machine reconfigures from one instance to another, if necessary, reads data from the input port, processes the data, and writes the data to the output port.

19. The system of claim 18 wherein the finite state machine further generates a signal indicating completion of the execution and re-enters an idle state.

20. A system for flow control in processing nodes of an adaptive computing engine (ACE), the system comprising:
a plurality of finite state machines, each finite state machine for performing a task;
control logic for determining task parameter status for the task and identifying the task as executable; and
a task queue for storing executable tasks transferred by the control logic and issuing the executable tasks to the plurality of finite state machines.

21. The system of claim 20 wherein the plurality of finite state machines form an execution unit for a processing node within an adaptive computing engine.

22. The system of claim 20 wherein the control logic determines a status of an input port, an output port, a finite state machine idle state, and an instance of the finite state machine.

23. The system of claim 22 wherein the control logic identifies a task as executable when the input port and output port are available and the finite state machine is idle.
